(19) United States
(12) Patent Application Publication
(10) Pub. No.: US 2025/0181962 A1
(43) Pub. Date: Jun. 5, 2025

(54) PEER TO PEER AUTOMATION EXECUTION AND RESPONSE

(71) Applicant: INTERNATIONAL BUSINESS MACHINES CORPORATION, Armonk, NY (US)

(72) Inventors: Melanie Dauber, Oceanside, NY (US); Jeremy R. Fox, Georgetown, TX (US); Zachary A. Silverstein, Georgetown, TX (US); Jacob Ryan Jepperson, St. Paul, MN (US); Logan Bailey, Atlanta, GA (US)

(21) Appl. No.: 18/524,423

(22) Filed: Nov. 30, 2023

(51) Int. Cl. G06N 20/00; G05B 19/4155

(52) U.S. Cl. CPC G06N 20/00; G05B 19/4155; G05B 2219/50391

(57) ABSTRACT

Embodiments receive an opt-in to give consent to capture information which determines whether a plurality of secondary users encounters an error, determine that a primary user, different from the secondary users, encounters the error, engage the primary user with the secondary users through a user interface (UI) to ask whether the secondary users have also encountered the error that the primary user encountered, generate a robot process automation (RPA) bot which compiles and runs a plurality of tests for executing an automated workflow verification process for each of the secondary users, perform global tracking for similar automated workflow verification processes as the RPA bot in multiple environments, and train an artificial intelligence (AI) model based on success metrics of the RPA bot and the similar automated workflow verification processes in multiple environments.

### BACKGROUND

Aspects of the present invention relate generally to peer to peer automation execution and response and, more particularly, to peer to peer privileged local automation execution and response.

When a problem is identified, users typically post in a community forum and ask a group if they are facing a same problem. Members of the group may then stop their current workflow to verify if the problem has also impacted them.

### SUMMARY

In a first aspect of the invention, there is a computer-implemented method including: receiving, by a processor set, an opt-in to give consent to capture information which determines whether a plurality of secondary users encounters an error; determining, by the processor set, that a primary user, different from the secondary users, encounters the error; engaging, by the processor set, the primary user with the secondary users through a user interface (UI) to ask whether the secondary users have also encountered the error that the primary user encountered; generating, by the processor set, a robotic process automation (RPA) bot which compiles and runs a plurality of tests for executing an automated workflow verification process for each of the secondary users; performing, by the processor set, global tracking for similar automated workflow verification process as the RPA bot in multiple environments; and training, by the processor set, an artificial intelligence (AI) model based on success metrics of the RPA bot and the similar automated workflow verification processes in multiple environments.

In another aspect of the invention, there is a computer program product including one or more computer readable storage media having program instructions collectively stored on the one or more computer readable storage media. The program instructions are executable to: receive an opt-in to give consent to capture information which determines whether a plurality of other users encounters an error; determine that a primary user, different from a secondary user, encounters the error; engage the secondary user to ask how many of the other users have also encountered the error that the primary user encountered; generate a robotic process automation (RPA) bot which compiles and runs a plurality of tests for executing an automated workflow verification process for each of the other users; perform global tracking for similar automated workflow verification processes as the RPA bot in multiple environments; and train an artificial intelligence (AI) model based on success metrics of the RPA bot and the similar automated workflow verification processes in multiple environments.

In another aspect of the invention, there is a system including a processor set, one or more computer readable storage media, and program instructions collectively stored on the one or more computer readable storage media. The program instructions are executable to: receive an opt-in to give consent to capture information which determines whether a plurality of secondary users encounters an error; determine that a primary user, different from the secondary users, encounters the error; engage the primary users with the secondary users through a user interface (UI) to ask whether the secondary users have also encountered the error that the primary user encountered; generate a robotic process automation (RPA) bot which compiles and runs a plurality of tests for executing an automated workflow verification process for each of the secondary users; perform global tracking for similar automated workflow verification process as the RPA bot in multiple environments; and train an artificial intelligence (AI) model based on success metrics of the RPA bot and the similar automated workflow verification processes in multiple environments. The success metrics include optical character recognition (OCR) metrics, screen comparison metrics, and whether a secondary user was unable to successfully execute the automated workflow verification process.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a flowchart of another exemplary method in accordance with aspects of the present invention.

FIG. 5 shows a flowchart of another exemplary method in accordance with aspects of the present invention.

### DETAILED DESCRIPTION

In a first aspect of the invention, there is a computer-implemented method including: receiving, by a processor set, an opt-in to give consent to capture information which determines whether a plurality of secondary users encounters an error, determining, by the processor set, that a primary user, different from the secondary users, encounters the error, engaging, by the processor set, the primary user with the secondary users through a user interface (UI) to ask whether the secondary users have also encountered the error that the primary user encountered, generating, by the processor set, a robot process automation (RPA) bot which compiles and runs a plurality of tests for executing an automated workflow verification process for each of the secondary users, performing, by the processor set, global tracking for similar automated workflow verification processes as the RPA bot in multiple environments, and training, by the processor set, an artificial intelligence (AI) model based on success metrics of the RPA bot and the similar automated workflow verification processes in multiple environments. In particular, embodiments may perform automation of a workflow process to determine how many users are impacted by an error.

The computer-implemented method may include providing feedback using the AI model to improve response accuracy in real-time. In particular, embodiments may perform automation of a workflow process by providing real-time feedback to improve accuracy using the AI model.

The computer-implemented method may include the error being a problem related to a local computing machine of the primary user. In particular, embodiments may perform automation of a workflow process in for a problem related to a local computing machine of the primary user.

The computer-implemented method may include the opt-in giving consent to run in a background on a local computing machine of each of the plurality of secondary users. In particular, embodiments may perform automation of the opt-in giving consent by running in a background on a local computing machine of each of the plurality of secondary users.

The computer-implemented method may include presenting a consent and complete button to the secondary users to opt-in to executing the automated workflow verification processes. In particular, embodiments may perform automation of a workflow process by presenting a consent and complete button to secondary users.

The computer-implemented method may include generating the RPA bot in response to at least one of the secondary users pressing the consent and complete button to opt-in to executing the automated workflow verification process. In particular, embodiments may perform automation of a workflow process by generating the RPA button in response to at least one of the secondary users pressing the consent and complete button.

The computer-implemented method may include the success metrics including optical character recognition (OCR) metrics and screen comparison metrics. In particular, embodiments may perform automation of a workflow process by having success metrics including OCR metrics and screen comparison metrics.

The computer-implemented method may include the success metrics including whether a secondary user was unable to successfully execute the automated workflow verification process. In particular, embodiments may perform automation of a workflow process by having success metrics including whether a secondary user was unable to successfully execute the automated workflow verification process.

The computer-implemented method may include the UI including a chat system. In particular, embodiments may perform automation of a workflow process by engaging secondary users with the primary user through the UI including a chat system.

The computer-implemented method may include the opt-in giving consent to capture information on a local computing machine of each of the plurality of secondary users. In particular, embodiments may perform automation of a workflow process by capturing information on a local computing machine.

In another aspect of the invention, there is a computer program product including program instructions executable to: receive an opt-in to give consent to capture information which determines whether a plurality of other users encounters an error, determine that a primary user, different from a secondary user, encounters the error, engage the primary user with the secondary user through a user interface (UI) to ask how many of the other users have also encountered the error that the primary user encountered, generate a robot process automation (RPA) bot which compiles and runs a plurality of tests for executing an automated workflow verification process for each of the other users, perform global tracking for similar automated workflow verification process as the RPA bot in multiple environments, and train an artificial intelligence (AI) model based on success metrics of the RPA bot and the similar automated workflow verification processes in multiple environments. In particular, embodiments may perform automation of a workflow process to determine how many users are impacted by an error.

The computer program product may include providing feedback using the AI model to improve response accuracy in real-time. In particular, embodiments may perform automation of a workflow process by providing feedback using the AI model.

The computer program product may include the error being a problem related to a local computing machine of the primary user. In particular, embodiments may perform automation of a workflow process for a problem related to a local computing machine of the primary user.

The computer program product may include the opt-in giving consent to run in a background on a local computing machine of each of the plurality of secondary users. In particular, embodiments may perform automation of the opt-in giving consent by running in a background on a local computing machine of each of the plurality of secondary users.

The computer program product may include presenting a consent and complete button to the secondary users to opt-in to executing the automated workflow verification processes. In particular, embodiments may perform automation of a workflow process by presenting a consent and complete button to secondary users.

The computer program product may include generating the RPA bot in response to at least one of the secondary users pressing the consent and complete button to opt-in to executing the automated workflow verification process. In particular, embodiments may perform automation of a workflow process by generating the RPA button in response to at least one of the secondary users pressing the consent and complete button.

The computer program product may include the success metrics including optical character recognition (OCR) metrics and screen comparison metrics. In particular, embodiments may perform automation of a workflow process by having success metrics including OCR metrics and screen comparison metrics.

The computer program product may include the success metrics including whether a secondary user was unable to successfully execute the automated workflow verification process. In particular, embodiments may perform automation of a workflow process by having success metrics including whether a secondary user was unable to successfully execute the automated workflow verification process.

The computer program product may include the UI including a chat system. In particular, embodiments may perform automation of a workflow process by engaging secondary users with the primary user through the UI including a chat system.

In another aspect of the invention, there is a system including program instructions executable to: receive an opt-in to give consent to capture information which determines whether a plurality of secondary users encounters an error, determine that a primary user, different from the secondary users, encounters the error, engage the primary user with the secondary users through a user interface (UI) to ask whether the secondary users have also encountered the error that the primary user encountered, generate a robot process automation (RPA) bot which compiles and runs a plurality of tests for executing an automated workflow verification process for each of the secondary users, perform global tracking for similar automated workflow verification processes as the RPA bot in multiple environments, and train an artificial intelligence (AI) model based on success metrics of the RPA bot and the similar automated workflow verification processes in multiple environments. The success metrics include optical character recognition (OCR) metrics, screen comparison metrics, and whether a secondary user was unable to successfully execute the automated workflow verification process. In particular, embodiments may perform automation of a workflow process to determine how many users are impacted by an error.

Aspects of the present invention relate generally to peer to peer automation execution and response and, more particularly, to peer to peer privileged local automation execution and response. Embodiments of the present invention validate if users have been impacted by an existing problem with a decision to “opt-in” and press a button. Embodiments of the present invention automate and anonymize a process to allow a plurality of users to understand how many systems were impacted by a problem. Embodiments of the present invention also include a consent and complete button for a user to opt-in to allow an automated workflow to securely run to verify that the user is impacted by the problem. Embodiments of the present invention allow the user to determine that other users were impacted by the problem. Embodiments of the present invention also provide anonymization and privacy of the users that are impacted by the problem. Embodiments of the present invention can be implemented in various environments, such as a conference room, a virtual web conferencing system with object recognition, and a chat system. In embodiments, the chat system may be Slack®. Slack is a registered trademark of Salesforce. However, embodiments are not limited to this example, and various virtual web conferencing and chat systems can be used.

Embodiments of the present invention provide an automated process for determining how many users are impacted by a particular problem. In comparison, conventional systems require users to stop their current workflow and implement a manual process to verify if the particular problem also affects them and then manually report the results. Embodiments of the present invention provide the users with an automated process which verifies whether the particular problem also affects them. Further, embodiments of the present invention do not interrupt the current workflow processes of a user. Embodiments of the present invention also provide a faster way of determining an impact within multi-environments in comparison to manual processes within conventional methods. Embodiments of the present invention also improve accuracy of problem detection using an artificial intelligence (AI) model in communication with a knowledge corpus.

Embodiments of the present invention include a highly computationally efficient system, method, and computer program product for providing peer to peer automation execution and response. Accordingly, implementations of the present invention provide an improvement (i.e., technical solution) to a problem arising in the technical field of manually determining how many users have been impacted by a particular problem. In particular, embodiments of the present invention use an automated process for determining how many users have been impacted by the particular problem. In addition, implementations of the present invention provide a faster way of determining how many users have been impacted by the particular problem. Embodiments of the present invention also use an AI model to improve accuracy of problem detection.

Implementations of the present invention are necessarily rooted in computer technology. For example, the step of utilizing an AI model to improve accuracy of problem detection is computer-based and cannot be performed in the human mind. Training and building the AI model is, by definition, performed by a computer and cannot practically be performed in the human mind (or with pen and paper) due to the complexity and massive amounts of calculations involved. For example, training and building the AI model in embodiments of the present invention may use artificial intelligence to build and train the AI model using multi-environment data across global systems to improve accuracy of problem detection. In particular, training and building the AI model performs a large amount of processing of multi-environment data and modeling of parameters to train the AI model such that the AI model generates an output in real time (or near real time). Given the scale and complexity of processing multi-environment data and modeling of parameters, it is simply not possible for the human mind, or for a person using pen and paper, to perform the number of calculations involved in training and/or building the AI model.

Aspects of the present invention include a method, system, and computer program product for peer to peer privileged local automation execution and response. For example, a computer-implemented method includes: a system comprising an ad hoc generated button for users to opt-in and allow an execution of automated workflows to securely run and provide a response in a social collaboration interaction; a system comprising anonymized user data to determine if the problem has impacted multiple users and performing global tracking of similar workflow execution to quantify the impact across the multiple users; a system comprising a response to indicate to the user if the problem has been verified to impact other users; and a system to tally all of the aggregate responses to indicate the pervasiveness of the problem with a dynamic counter button function in real-time. The computer-implemented method also includes capturing an action of a user based on recency and relevancy to generate an ad-hoc workflow. The computer-implemented method also includes providing an automated optical character recognition (OCR) and screen comparison for feedback and similarity scoring.

It should be understood that, to the extent implementations of the invention collect, store, or employ personal information provided by, or obtained from, individuals (for example, a primary user, a plurality of secondary users, and other users), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as peer to peer code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

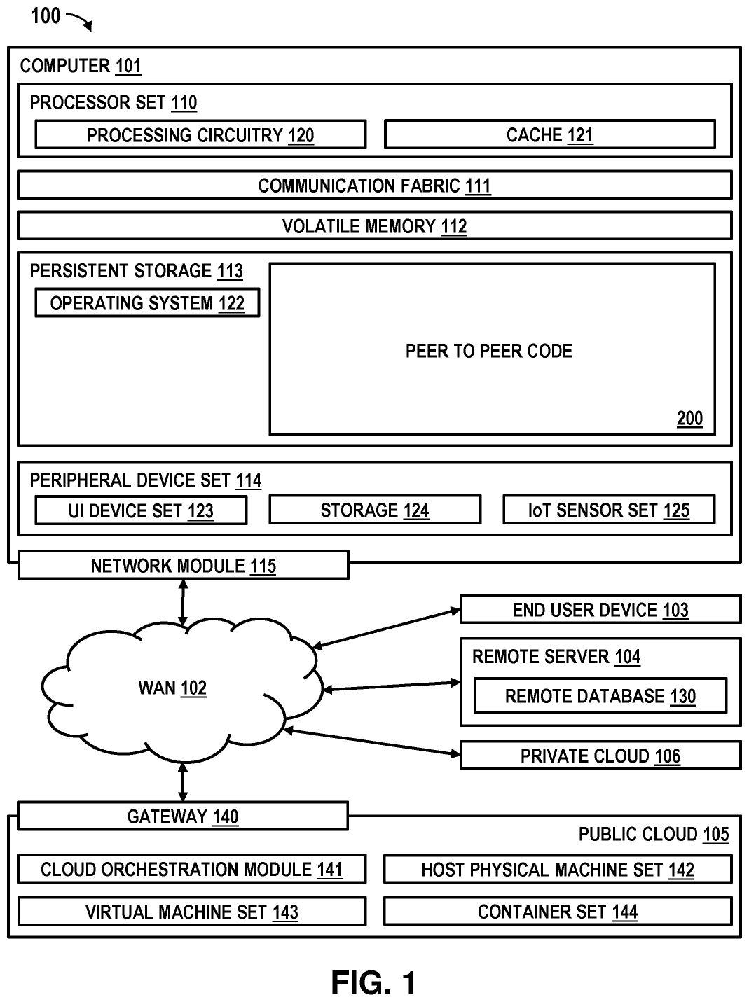

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

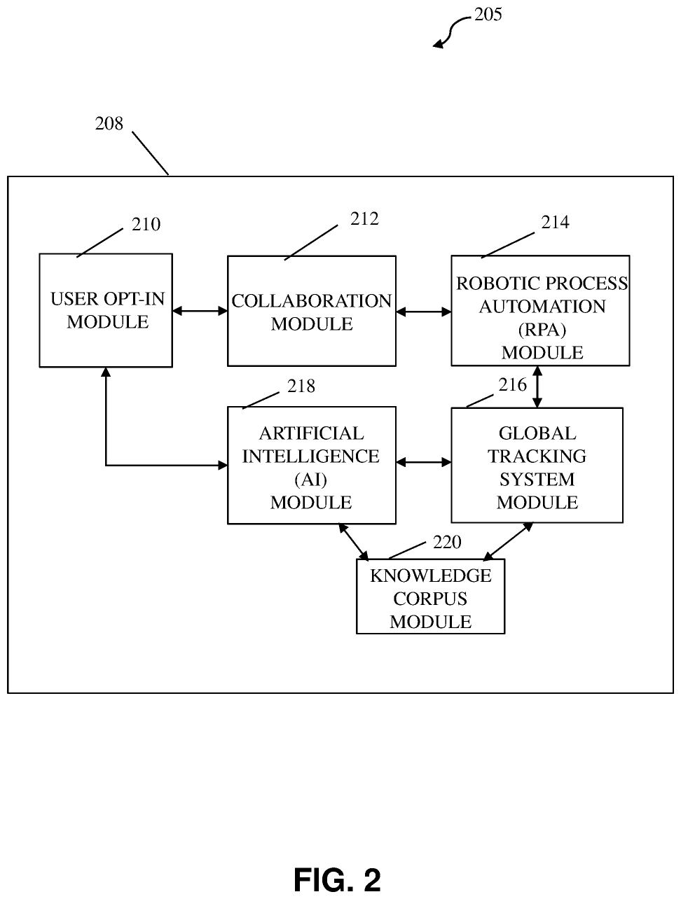

FIG. 2 shows a block diagram of an exemplary environment 205 in accordance with aspects of the present invention. In embodiments, the environment 205 includes a peer to peer server 208, which may comprise one or more instances of the computer 101 of FIG. 1. In other examples, the peer to peer server 208 comprises one or more virtual machines or one or more containers running on one or more instances of the computer 101 of FIG. 1.

In embodiments, the peer to peer server 208 of FIG. 2 comprises a user opt-in module 210, a collaboration module 212, a robotic process automation (RPA) module 214, a global tracking system module 216, an artificial intelligence (AI) module 218, a knowledge corpus module 220, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the present invention as described herein. These modules of the code of block 200 are executable by the processing circuitry 120 of FIG. 1 to perform the inventive methods as described herein. The peer to peer server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In FIG. 2, and in accordance with aspects of the present invention, the user opt-in module 210 persists on one of a cloud network or a local computing machine for at least one user. In embodiments, the user opt-in module 210 persists on one of the cloud network or the local computing machine for a primary user who encounters an error (i.e., a problem related to the local computing machine of the primary user). In particular, the primary user who encounters the error gives consent to the user opt-in module 210 to persist on one of the cloud network or the local computing machine for capturing keystrokes, input data, and information of the local computing machine. In embodiments, the primary user gives consent to the user opt-in module 210 to persist on one of the cloud network or the local computing machine for capturing keystrokes, input data, and information of the local computing machine and generating an ad-hoc workflow based on recency and relevancy (e.g., application name and time) of the captured capturing keystrokes, input data, and information. Accordingly, the user opt-in module 210 enables capturing keystrokes, input data, and information to the local computing machine for recording a plurality of steps that the primary user performs for encountering the error. In other embodiments, the user opt-in module 210 persists on one of the cloud network or the local computing machine of a plurality of users (e.g., the primary user, at least one secondary user, and other users) within a system. In this situation, the plurality of users within the system must give consent to the user opt-in module 210 to enable capturing keystrokes, input data, and information to the local computing machine for recording at least one step for determining whether a secondary user also encounters a same error as the primary user. For example, the user opt-in module 210 may capture information during the automated workflow verification process of the secondary user to determine whether the secondary user also encounters the same error as the primary error. In embodiments, the user opt-in module 210 runs in a background of the cloud network or the local computing machine of the at least one user to avoid interrupting a workflow of a user. In embodiments, the user opt-in module 210 sends any captured keystrokes, input data, and information from at least one user (e.g., a primary user, a secondary user, other users) to the collaboration module 212. In embodiments, the opt-in module 210 may be implemented as an ad hoc button (e.g., a consent and complete button) for the at least one user to give consent. In particular, the ad hoc button allows for users to opt in and allow the execution of automated workflows to securely run and provide a response in a social collaboration interaction.

In FIG. 2, and in accordance with aspects of the present invention, the collaboration module 212 receives the captured keystrokes, input data, and information from at least one user in the user opt-in module 210. The collaboration module 212 includes a user interface (UI) module for the primary user to engage with secondary users via a social collaboration interaction. As an example, the collaboration module 212 includes the UI module for the primary user to engage with secondary users. In embodiments, the UI module may be a web conferencing or a chat system. However, embodiments are not limited to this example, and may be implemented in any chat system, any conference room, or any virtual web conferencing service with object recognition to determine hand raises and determine if each of the secondary users want to opt-in using an ad hoc button (e.g., a consent and complete button) to verify whether each of the secondary users were impacted by the same error as the primary user. In particular, the collaboration module 212 with the UI module facilitates the primary user discussing the error with the secondary users and asking the secondary users whether they encountered the same error as the primary user. In this embodiment, each of the secondary users who opt-in using the ad hoc button trigger the RPA module 214 to securely execute an automated workflow verification process for each of the secondary users.

In FIG. 2, and in accordance with aspects of the present invention, the collaboration module 212 includes the UI module for the primary user to engage with a secondary user. The UI module may be a web conferencing or a chat system. However, embodiments are not limited to this example, and may be implemented with object recognition to determine a hand raise of the secondary user and determine if the secondary user automates a verification process using an ad hoc button (e.g., a consent and complete button) to verify how many other users were impacted by the same error as the primary user. In particular, the collaboration module 212 with the UI module facilitates the primary user discussing the error with the secondary user and asking the secondary user how many other users have encountered the same error as the primary user. In this embodiment, the secondary user who automates the verification process using the ad hoc button triggers the RPA module 214 to securely execute an automated workflow verification process for each of the other users.

In FIG. 2, and in accordance with aspects of the present invention, the RPA module 214 generates a robot process automation (RPA) bot which compiles and runs a plurality of tests for executing the automated workflow verification process for each of the secondary users. In embodiments, the RPA bot is generated in response to the secondary users opting-in to trigger the execution of the automated workflow verification processes in a user environment of each the secondary users. In embodiments, the RPA module 214 determines if the same error of the primary user has impacted multiple users by checking anonymized user data. In embodiments, the RPA bot generates a response containing success metrics of the execution of the automated workflow verification process for each of the secondary users and sends the response containing success metrics to the global tracking system module 216. In embodiments, the response is automated and includes one of a yes or a no to indicate to the primary user if the problem has been verified to impact other users. In embodiments, the success metrics include automated optical character recognition (OCR) metrics and screen comparison metrics of the secondary users for feedback and similarity scoring. The success metrics may also include whether a particular user was unable to successfully execute the automated workflow verification process.

In FIG. 2, and in accordance with aspects of the present invention, the RPA module 214 generates the RPA bot which compiles and runs a plurality of tests for executing the automated workflow verification process for each of the other users. In embodiments, the RPA bot is generated by the secondary user opting-in to automate the verification process by triggering the execution of the automated workflow verification processes in a user environment of each the other users. In embodiments, the RPA bot generates a response containing success metrics of the execution of the automated workflow verification process for each of the other users and sends the response containing success metrics to the global tracking system module 216. In embodiments, the response is automated and includes one of a yes or a no to indicate to the primary user if the problem has been verified to impact other users. In embodiments, the success metrics include automated OCR metrics and screen comparison metrics of the other users for feedback and similarity scoring. The success metrics may also include whether a particular user was unable to successfully execute the automated workflow verification process.

In FIG. 2, and in accordance with aspects of the present invention, the global tracking system module 216 performs similar automated workflow verification processes as the RPA module 214 in multiple environments. In embodiments, the global tracking system module 216 performs execution of the automated workflow verification process across an entire chat system, an entire organization (e.g., a corporate department), an entire corporation, an entire industry, or an entire country to capture how pervasive the error of the primary user across multiple environments. In embodiments, the global tracking system module 216 determines an entire organization, an entire corporation, an entire industry, or an entire country based on a pre-defined email group for each environment (e.g., an email group for a corporate department, an email group for an entire corporation, an email group for the entire chat system, etc.). Therefore, the global tracking system module 216 may determine pervasiveness across a broader scope of environments than a smaller set of secondary users who may be on a same corporate department as the primary user. In embodiments, the global tracking system module 216 performs similar automated workflow verification processes as the automated workflow verification processes for the secondary users. In particular, the global tracking system module 216 performs similar automated workflow verification processes as the automated workflow verification processes for the secondary users by providing an automated workflow verification process which is above a predetermined scoring threshold of a similarity scoring in comparison to the automated workflow verification processes for the secondary users. In embodiments, similarity scoring of the automated workflow verification of the global tracking system module 216 in comparison to the automated workflow verification process is calculated using OCR and screen comparison metrics. In other embodiments, the global tracking system module 216 performs similar automated workflow verification processes as the automated workflow verification processes for the other users. In embodiments, the global tracking system module 216 also generates responses containing success metrics of the execution of the automated workflow verification process and sends all of the responses containing success metrics of the execution of the automated workflow verification processes to the AI module 218 and the knowledge corpus module 220. In embodiments, the success metrics includes a tally of all aggregated responses to indicate the pervasiveness of the error across multiple environments. Further, in embodiments, the success metrics includes a dynamic button including a counter function to correspond with the tally of all aggregated responses in real-time. As described above, the success metrics include automated OCR metrics and screen comparison metrics for feedback and similarity scoring. The success metrics may also include whether a particular user was unable to successfully execute the automated workflow verification process.

In FIG. 2, and in accordance with aspects of the present invention, the AI module 218 receives all of the success metrics which include automated OCR metrics, screen comparison metrics, and whether a particular user was unable to successfully execute the automated workflow verification process. The AI module 218 may include an AI model which receives all of the success metrics from the RPA module 214 and the global tracking system module 216 and trains the AI model using all of the success metrics from the RPA module 214 and the global tracking system module 216. The AI model may also calculate similarity scoring between different users (e.g., secondary users or other users). The AI model may output similarity scoring, a success metric output, and other feedback information of users (e.g., secondary users or other users) to the user opt-in module 210 for providing feedback to improve response (i.e., success metrics) accuracy in real-time (or near real-time). The AI model 218 may also send all of the success metrics which include the automated OCR metrics, the screen comparison metrics, and whether a particular user was unable to successfully execute the automated workflow verification process to the knowledge corpus module 220

In FIG. 2, and in accordance with aspects of the present invention, the knowledge corpus module 220 may include a knowledge corpus database which stores all of the success metrics which include the automated OCR metrics, the screen comparison metrics, and whether a particular user was unable to successfully execute the automated workflow verification process. The knowledge corpus database may also log and store user data related to the primary user, the secondary users, other users, etc., for future reference and analysis by the AI model 218.

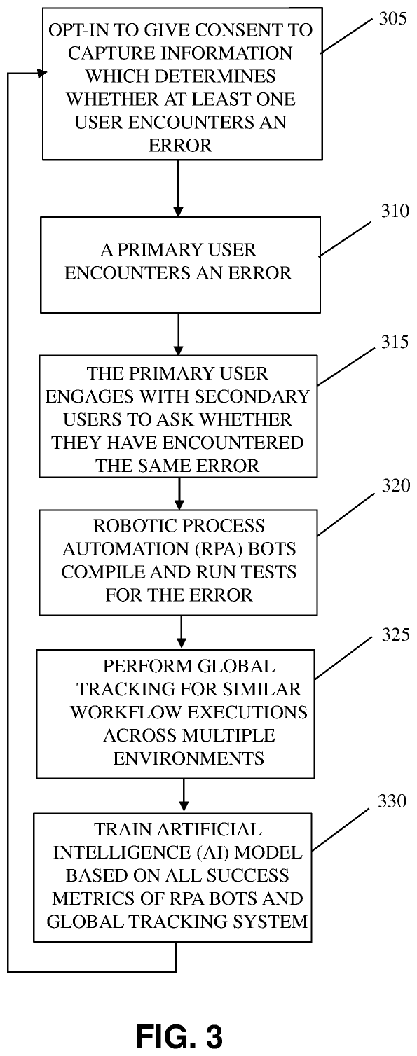

FIG. 3 shows a flowchart of an exemplary method in accordance with aspects of the present invention. Steps of the method may be carried out in the environment of FIG. 2 and are described with reference to elements depicted in FIG. 2.

In embodiments of FIG. 3, at step 305, the system receives, at the user opt-in module 210, an opt-in to give consent to capture information which determines whether at least one user (e.g., a primary user, a secondary user, other users) encounters an error. In embodiments and as described with respect to FIG. 2, the user opt-in module 210 captures information during an automated workflow verification process of the secondary user to determine whether the secondary user also encounters the same error as the primary error.

At step 310, the system determines, at the user opt-in module 210, that a primary user encounters an error. In embodiments and as described with respect to FIG. 2, the error may be a problem that occurs on the local computing machine of the primary user.

At step 315, the system allows, at the collaboration module 212, the primary user to engage with a plurality of secondary users though a user interface (UI) to ask whether the secondary users have encountered a same error as the primary user. In embodiments and as described with respect to FIG. 2, the collaboration module 212 allows the primary user to engage with the plurality of secondary users via a chat system.

At step 320, the system generates, at the RPA module 214, a RPA bot which compiles and runs a plurality of tests for executing an automated workflow verification process for each of the secondary users. In embodiments and as described with respect to FIG. 2, the RPA bot generates a response containing success metrics of the execution of the automated workflow verification process for each of the secondary users and sends the response containing success metrics to the global tracking system 216.

At step 325, the system performs, at the global tracking system module 216, global tracking for similar automated workflow verification processes as the RPA module 214 in multiple environments. In embodiments and as described with respect to FIG. 2, the global tracking system 216 performs global tracking for the similar automated workflow verification processes in at least one of an entire chat system, an entire organization, an entire corporation, an entire industry, or an entire country to capture how pervasive the error of the primary user is across multiple environments.

At step 330, the system trains, at the AI module 218, an artificial intelligence (AI) model based on success metrics of the RPA bot and the global tracking system 216. In embodiments and as described with respect to FIG. 2, the AI model may output similarity scoring, a success metric output, and other feedback information of users (e.g., secondary users) to the user opt-in module 210 for providing feedback to improve response (i.e., success metrics) accuracy in real-time (or near real-time).

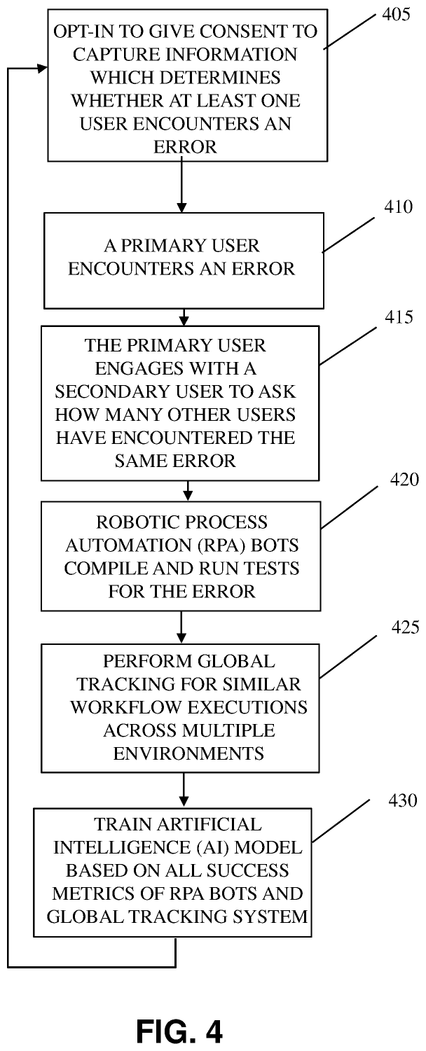

FIG. 4 shows a flowchart of an exemplary method in accordance with aspects of the present invention. Steps of the method may be carried out in the environment of FIG. 2 and are described with reference to elements depicted in FIG. 2.

In embodiments of FIG. 4, at step 405, the system receives, at the user opt-in module 210, an opt-in to give consent to capture information which determines whether at least one user (e.g., a primary user, a secondary user, other users) encounters an error. In embodiments and as described with respect to FIG. 2, the user opt-in module 210 captures information during an automated workflow verification process of other users to determine whether the other users also encounter the same error as the primary error.

At step 410, the system determines, at the user opt-in module 210, that a primary user encounters an error. In embodiments and as described with respect to FIG. 2, the error may be a problem that occurs on the local computing machine of the primary user.

At step 415, the system allows, at the collaboration module 212, the primary user to engage with a secondary user through a user interface (UI) to ask how many other users have encountered a same error as the primary user. In embodiments and as described with respect to FIG. 2, the collaboration module 212 allows the primary user to engage with the secondary user via a chat system.

At step 420, the system generates, at the RPA module 214, a RPA bot which compiles and runs a plurality of tests for executing an automated workflow verification process for each of the other users. In embodiments and as described with respect to FIG. 2, the RPA bot generates a response containing success metrics of the execution of the automated workflow verification process for each of the other users and sends the response containing success metrics to the global tracking system 216.

At step 425, the system performs, at the global tracking system 216, global tracking for similar automated workflow verification processes as the RPA module 214 in multiple environments. In embodiments and as described with respect to FIG. 2, the global tracking system 216 performs global tracking for the similar automated workflow verification processes in at least one of an entire chat system, an entire organization, an entire corporation, an entire industry, or an entire country to capture how pervasive the error of the primary user is across multiple environments.

At step 430, the system trains, at the AI module 218, an artificial intelligence (AI) model based on success metrics of the RPA bot and the global tracking system 216. In embodiments and as described with respect to FIG. 2, the AI model may output similarity scoring, a success metric output, and other feedback information of users (e.g., other users) to the user opt-in module 210 for providing feedback to improve response (i.e., success metrics) accuracy in real-time (or near real-time).

In embodiments, the peer to peer server 208 is configured to be used in different scenarios. In a first example, Melanie works in a sales department of a large company and is responsible for managing a team of sales representatives. At the end of every month, Melanie has to go through the performance of each sales representative to calculate a commission. However, an accountant on a same team as Melanie mentioned that there was an accounting problem to Melanie in a web conferencing or a chat system. Melanie is able to press an “consent and complete button” to automate a process with the peer to peer server 208 for checking how many other users throughout the company sales tracking team have the same accounting problem. In particular, the peer to peer server 208 is able to query all the sales representatives via Slack™ to look for other users that have the same accounting problem. In this example, the peer to peer server 208 determines that 24 sales representatives were affected (i.e., impacted by the same accounting problem) and 287 accounts were not affected. By using the peer to peer server 208, Melanie is able to save a lot of time and focus on other important tasks during her job.

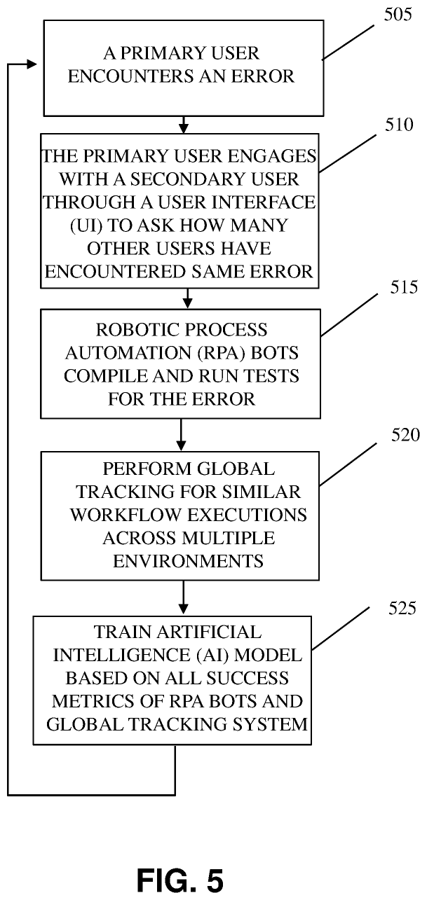

FIG. 5 shows a flowchart of an exemplary method in accordance with aspects of the present invention. Steps of the method may be carried out in the environment of FIG. 2 and are described with reference to elements depicted in FIG. 2 and the first example.

At step 505, the system determines, at the user opt-in module 210, that a primary user encounters an error. In embodiments and as described with respect to the first example, an accountant encounters an error (e.g., an accounting problem). At step 510, the system engages, at the collaboration module 212, the primary user with a secondary user through a user interface (UI) to ask how many other users (e.g., other users in a team of sales representatives) have encountered a same error.

At step 515, the system generates, at the RPA module 214, an RPA bot which compiles and runs a plurality of tests for executing an automated workflow verification process for each of the other users. In embodiments and as described with respect to the first example, the RPA bot compiles and runs the plurality of tests for executing the automated workflow verification process for each of the other users in response to the secondary user pressing the consent and complete button. In further embodiments and as described with respect to the first example, the RPA bot generates a response containing success metrics (e.g., how many other users in the team of sales representatives were affected by the same accounting problem) of the execution of the automated workflow verification process for each of the other users and sends the response containing success metrics to the global tracking system 216.

At step 520, the system performs, at the global tracking system 216, global tracking for similar automated workflow verification processes as the RPA module 214 in multiple environments. In embodiments and as described with respect to the first example, the global tracking system 216 performs global tracking for the similar automated workflow verification processes in another environment (e.g., throughout the company sales tracking team) to capture how pervasive the error of the primary user is across multiple environments. As described above, the global tracking system determines that the error (e.g., the accounting problem) affected 24 sales representatives, but 287 other accounts were not affected.

At step 525, the system trains, at the AI module 218, an artificial intelligence (AI) model based on success metrics of the RPA bot and the global tracking system 216. In embodiments and as described with respect to FIG. 2, the AI model may output similarity scoring, a success metric output, and other feedback information of users (e.g., other users) to the user opt-in module 210 for providing feedback to improve response (i.e., success metrics) accuracy in real-time (or near real-time).

In a second example, Jeremy is not seeing an amount owed to him within his paycheck for services completed. Jeremey posted a question to other employees within a web conferencing or a chat system to see whether they were also having a same error with their paychecks. The peer to peer server 208 generates an “consent and complete button” for all of the other employees Jeremy posted the question to. Once the other employees press the “consent and complete button”, an automated verification automated workflow process is executed which validates whether the other employees encounter the same error with their paychecks. Since it is easy for the other employees to press the “consent and complete button”, Jeremy gets a 700% increased participation rate by the other employees in comparison to simply asking the question in Slack™ and requesting the other employees to perform manual processes to determine whether they encounter the same error with their paychecks.

In a third example, Mark notices that his commission check did not come through in his paycheck. In conventional systems, Mark would have to check with other people in the sales department, finance department, etc., to see whether other employees have been impacted by the same paycheck error. In conventional systems, the other employees would have to stop what they are doing and manually check their paystubs to verify whether they have been impacted by the same paycheck error. In contrast, in the peer to peer server 208, Mark poses the question in a team Slack™ channel or a videoconferencing call with the team. In this situation, the peer to peer server 208 presents a “consent and complete button” to the recipients of Mark's question in the team Slack™ channel or the videoconferencing call. The team members simply press the “consent and complete button” and the peer to peer server 208 allows an automated workflow process to execute on a local computing machine of each team member who pressed the “consent and complete button”. The peer to peer server 208 executes the automated workflow process on a team member to determine whether the team member is also impacted by the same paycheck error. Further, for security purposes, Mark is only able to see that others were impacted by the same paycheck error, and is not able to see details of the users, such as how much others were paid to press the “consent and complete button”. Thus, the peer to peer server 208 anonymizes the team members and provides privacy of the team members.

In a fourth example, Logan encounters an issue with a node.js test application. Logan communicates with Zach over slack to see whether Zach has the same issue. Zach presses a “consent and complete button”, and an RPA bot is generated by the peer to peer server 208 to compile and run tests associated with the node.js test application and generate a response containing success metrics. Logan may also post to a Slack™ channel to see how pervasive the issue is with the node.js test application. However, although Jeremy presses the “consent and complete button”, the RPA bot of the peer to peer server 208 is not able to successfully compile and run tests associated with the node.js test application on a local computing environment of Jeremy. In particular, the local computing environment of Jeremy has different environmental settings which prevents the RPA bot to successfully compile and run tests. The peer to peer server 208 may then generate a response including success metrics for Zach and Jeremy and train an AI model for providing feedback to the system for improving response accuracy.

In embodiments, a service provider could offer to perform the processes described herein. In this case, the service provider can create, maintain, deploy, support, etc., the computer infrastructure that performs the process steps of the present invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the present invention provides a computer-implemented method, via a network. In this case, a computer infrastructure, such as computer 101 of FIG. 1, can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, an opt-in to give consent to capture information which determines whether a plurality of secondary users encounters an error;
determining, by the processor set, that a primary user, different from the secondary users, encounters the error;
engaging, by the processor set, the primary user with the secondary users though a user interface (UI) to ask whether the secondary users have also encountered the error that the primary user encountered;
generating, by the processor set, a robot process automation (RPA) bot which compiles and runs a plurality of tests for executing an automated workflow verification process for each of the secondary users;
performing, by the processor set, global tracking for similar automated workflow verification processes as the RPA bot in multiple environments; and
training, by the processor set, an artificial intelligence (AI) model based on success metrics of the RPA bot and the similar automated workflow verification processes in multiple environments.

2. The computer-implemented method of claim 1, further comprising providing feedback using the AI model to improve response accuracy in real-time.

3. The computer-implemented method of claim 1, wherein the error is a problem related to a local computing machine of the primary user.

4. The computer-implemented method of claim 1, wherein the opt-in gives consent to run in a background on a local computing machine of each of the plurality of secondary users.

5. The computer-implemented method of claim 1, further comprising presenting a consent and complete button to the secondary users to opt-in to executing the automated workflow verification process.

6. The computer-implemented method of claim 5, further comprising generating the RPA bot in response to at least one of the secondary users pressing the consent and complete button to opt-in to executing the automated workflow verification process.

7. The computer-implemented method of claim 1, wherein the success metrics comprise optical character recognition (OCR) metrics and screen comparison metrics.

8. The computer-implemented method of claim 7, wherein the success metrics further comprise whether a secondary user was unable to successfully execute the automated workflow verification process.

9. The computer-implemented method of claim 1, wherein the UI comprises a chat system.

10. The computer-implemented method of claim 1, wherein the opt-in gives consent to capture information on a local computing machine of each of the plurality of secondary users.

11. A computer program product comprising one or more computer readable storage media having program instructions collectively stored on the one or more computer readable storage media, the program instructions executable to:
receive an opt-in to give consent to capture information which determines whether a plurality of other users encounters an error;
determine that a primary user, different from a secondary user, encounters the error;
engage the primary user with the secondary user through a user interface (UI) to ask how many of the other users have also encountered the error that the primary user encountered;
generate a robot process automation (RPA) bot which compiles and runs a plurality of tests for executing an automated workflow verification process for each of the other users;
perform global tracking for similar automated workflow verification processes as the RPA bot in multiple environments; and
train an artificial intelligence (AI) model based on success metrics of the RPA bot and the similar automated workflow verification processes in multiple environments.

12. The computer program product of claim 11, further comprising providing feedback using the AI model to improve response accuracy in real-time.

13. The computer program product of claim 11, wherein the error is a problem related to a local computing machine of the primary user.

14. The computer program product of claim 11, wherein the opt-in gives consent to run in a background on a local computing machine of each of the plurality of other users.

15. The computer program product of claim 11, further comprising presenting a consent and complete button to the secondary users to opt-in to executing the automated workflow verification process.

16. The computer program product of claim 15, further comprising generating the RPA bot in response to at least one of the secondary users pressing the consent and complete button to opt-in to executing the automated workflow verification process.

17. The computer program product of claim 11, wherein the success metrics comprise optical character recognition (OCR) metrics and screen comparison metrics.

18. The computer program product of claim 17, wherein the success metrics further comprise whether a secondary user was unable to successfully execute the automated workflow verification process.

19. The computer program product of claim 11, wherein the UI comprises a chat system.

20. A system comprising:
a processor set, one or more computer readable storage media, and program instructions collectively stored on the one or more computer readable storage media, the program instructions executable to:
receive an opt-in to give consent to capture information which determines whether a plurality of secondary users encounters an error;
determine that a primary user, different from the secondary users, encounters the error;
engage the primary user with the secondary users through a user interface (UI) to ask whether the secondary users have also encountered the error that the primary user encountered;
generate a robot process automation (RPA) bot which compiles and runs a plurality of tests for executing an automated workflow verification process for each of the secondary users;
perform global tracking for similar automated workflow verification processes as the RPA bot in multiple environments; and
train an artificial intelligence (AI) model based on success metrics of the RPA bot and the similar automated workflow verification processes in multiple environments,
wherein the success metrics comprise optical character recognition (OCR) metrics, screen comparison metrics, and whether a secondary user was unable to successfully execute the automated workflow verification process.
